(19) United States
(12) Patent Application Publication
(10) Pub. No.: US 2020/0311785 A1
(43) Pub. Date: Oct. 1, 2020

(54) AUTOMATED VIRTUAL ASSET CATALOG FOR COMPUTER APPLICATIONS

(71) Applicant: Sony Interactive Entertainment LLC, San Mateo, CA (US)

(72) Inventors: Sylvain Lagrand, San Francisco, CA (US); Peter Winter, San Francisco, CA (US); Rohan Kharbanda, San Francisco, CA (US); Christopher Depizzol, Alameda, CA (US)

(21) Appl. No.: 16/370,793

(22) Filed: Mar. 29, 2019

(51) Int. Cl. G06Q 30/06

(52) U.S. Cl. CPC G06Q 30/0603; G06Q 30/0641

(57) ABSTRACT

A system facilitates acquisition of virtual assets by obtaining information about a user and information about one or more computer applications associated with the user. When the user navigates a device to a catalog screen for virtual assets for computer applications, the system automatically presents to the user a filtered listing of applications for which purchasable virtual assets are available to the user that is filtered according to the information about the user and/or the information about one or more computer applications associated with the user. When the user selects an application on the filtered listing, the system automatically presents to the user a filtered catalog of purchasable virtual assets that are available to the user for the selected application that is filtered according to the information about the user and/or the information about one or more computer applications associated with the user.

### FIELD OF THE INVENTION

The current disclosure is related to virtual market places. Specifically, aspects of the present disclosure are related to an automated catalog for virtual assets for computer applications.

### BACKGROUND OF THE INVENTION

Add-on sales, such as sales for virtual assets, are becoming a larger part of business in computer applications such as video games. These virtual assets, sometimes called add-ons, are typically in-game items such as weapons, vehicles, character skins, armor sets, pets, companions, mounts, etc. Virtual assets are often presented in online catalogs. These catalogs often present an ordered listing of all games available from a particular provider or for a particular game platform. Selecting a particular game in the catalog leads to a presenting of a listing of virtual assets for that game. The listing may be an alphabetical of game titles. Unfortunately, there are large numbers of games available, so it is often necessary to navigate through large numbers of titles to find a specific one of interest to a particular user. Some catalogs break down games by different categories, such as, genre (e.g., first person shooter, adventure, fantasy, sports), developer, platform, video content rating, and the like. However, even these categories can contain large numbers of games. Furthermore, only a few titles might be of interest to a particular user and they may be in different categories. A user therefore has to spend considerable time searching through titles to find the ones that are of interest.

Even once a user finds titles that are of interest additional searching among the add-ons for those titles may be necessary. For example, not all add-ons for a game are available for every platform on which the game is played. Some add-ons may only be available to users with a certain skill level. Other add-ons may not be available in a user's location due to legal or contractual restrictions.

Often purchases of games are driven by references from friends. A common occurrence before the rise of online only applications and DRM was friends lending games to other friends to try those games. Currently, there is no way for a user to lend out an online only application to other users. Additionally, there is no way for users to purchase virtual assets for games they do not own, for example a game that has been borrowed.

It is within this context that aspects of the present disclosure arise.

### BRIEF DESCRIPTION OF THE DRAWINGS

The teachings of the present invention can be readily understood by considering the following detailed description in conjunction with the accompanying drawings, in which:

FIG. 1 is a flow diagram of a method for acquiring virtual assets in a borrowed application according to an embodiment of the present invention.

FIG. 2 is a screen shot illustrating an example of a filtered listing of applications for which purchasable virtual assets are available presented to a user in accordance with aspects of the present disclosure.

FIG. 3 is a screen shot illustrating an example of a filtered catalog of purchasable virtual assets that are available to a user for the selected application presented to a user in accordance with aspects of the present disclosure.

FIG. 4 is a schematic diagram of a system that allows delivering virtual assets to users of a borrowed application according to aspects of the present disclosure.

FIG. 5 is a flow diagram of a method for acquiring virtual assets in a borrowed application according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Virtual assets are becoming a greater draw for purchasers of application. Users often have difficulty finding the virtual assets available for games they are currently play or games that they want to play. Additionally users sometimes try applications before they purchase them and while trying those applications a user may want to use a virtual asset that didn't come with the trial version of the game.

According to aspects of the present disclosure user acquisition of virtual assets for computer applications may be facilitated by an automated system that determines which applications are relevant to the user and which assets are available for those applications. This information may be filtered so that the relevant applications and available assets can be presented to the user in an organized way that reduces the amount of manual searching the user must do.

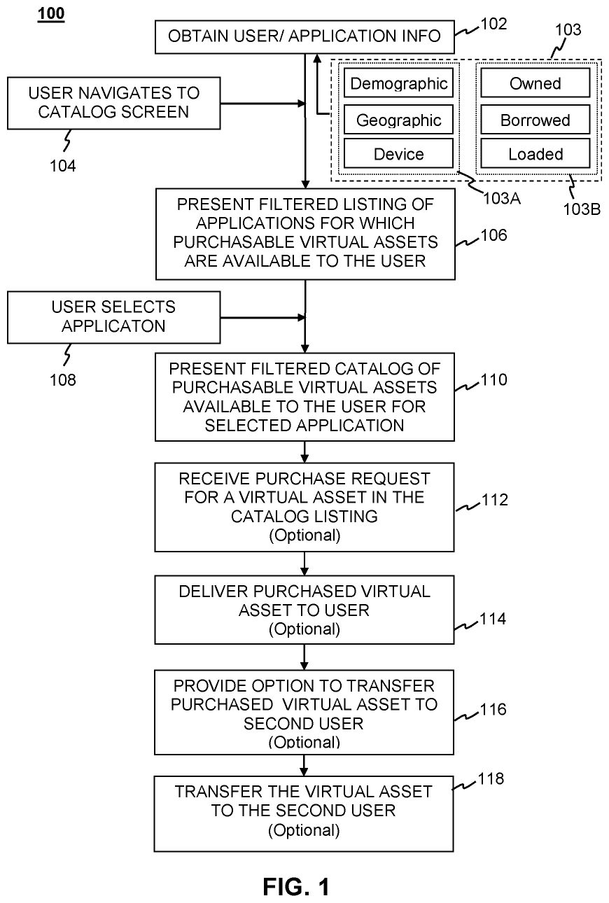

The flow diagram of FIG. 1 shows an example of a computer-implemented method 100 for facilitating acquisition of virtual assets for computer applications according to aspects of the present disclosure. According to the illustrated method a computer system may obtain information about a user and information 103 about one or more computer applications associated with the user, as generally indicated at 102. The information 103 generally includes user-related information 103A and application-related information 103B.

The user information 103A may include, e.g., demographic information, geographic information, and device information. Demographic information generally includes things like the user's age, race, religion, ethnicity, nationality, marital status, economic status, and the like. Geographic information may include things like the user's current jurisdiction of residence, e.g., city, county, state, province, country or the user's current physical location. This can be determined, e.g., from a GPS or other location-sensing component of a device that the user uses to access the system. Device information may include information about one or more devices associated with the user. Such information may include, device ID, IP address, device capabilities, e.g., processor type, processor speed, memory space available, storage space (e.g., hard disk space) available, and the like.

The application information 103B may include information identifying which applications the user owns, has borrowed, is otherwise associated with, e.g., applications the user has access to through a joint account with other users or through a device shared with other users. The application information may also include information identifying the corresponding producer, operating system, and/or version for such applications. In some implementations, the application information 103B may include information identifying which application or applications are currently loaded on the device the user is using access the system through which the user attempts to acquire virtual assets for those applications.

The system may obtain the information in several different ways. By way of example, the system may be implemented locally on a device through which the user interacts with the applications. In some such cases the applications may be loaded onto the device, e.g., a computer, laptop, or gaming console, through some physical medium, such as a compact disc (CD) or universal serial bus (USB) drive, e.g., a flash drive. In such implementations, the user's device may keep track of every application loaded into the device. In other implementations, the user's device accesses the applications on a remote server via a network, such as the internet. The user's applications, i.e., those the user can access, may be associated with an account through which the user can access the applications and associated data. In such cases, either the user's device or the remote server may keep track of each application the user can access.

When the user navigates a device to a catalog screen for virtual assets for computer applications, as indicated at 104, the system automatically presents to the user a filtered listing of applications for which purchasable virtual assets are available to the user, as indicated at 106. The user may navigate to the catalog screen in any suitable manner, e.g., through a graphical user interface if the system is local to the user's device or through a web browser if the system is on a server that is remote from the user's device.

The listing of applications that is automatically presented to the user is filtered according to the information about the user and/or the information about the applications associated with the user. These may include applications owned by the user, applications shared by the user with other users, applications borrowed from other users and applications to which the user otherwise has access. The list of applications to which the user has access may be filtered so that a few of the most relevant applications are presented most prominently. By way of example, and not by way of limitations, the system can filter the list of applications presented to the user so that those most recently used or most frequently appear more prominently, e.g., at the top of the list.

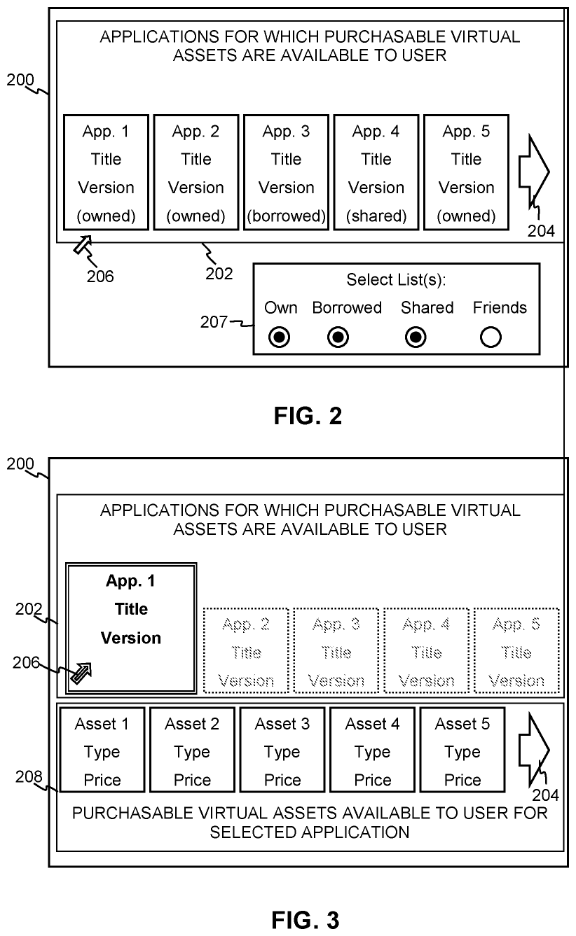

FIG. 2 illustrates a screen shot showing an example of how such a filtered listing may be presented to the user. In the illustrated example, the screen 200 shows the user a list 202 showing icons representing 5 different applications. Applications 1, 2, and 5 are owned by the user. Application 3 is borrowed and application 4 is shared with other users. Here, the system shows only five application icons. The user may own additional applications but the system has presented the five most relevant applications as determined from the user information 103A and/or application information 103B. In this example, the user can view additional applications by clicking on the arrow 204 to the right of the icons using a cursor 206.

In some implementations, the list 202 may be selectively limited to display only those applications that are owned or only those that are borrowed. In other implementations, the list 202 may display a listing of applications to which the user has opportunity to access through the user's association with other users. Such applications may include applications that are shared with others or those that are separately owned by others associated with the user, e.g., the user's friends, that the user may be able to borrow. There are a number of ways in which a system could determine which other users are associated with a given user. For example, and without limitation, other users could be associated with given user through social media. One or more other users could have with the given user through a multi-user online applications, e.g., a multiplayer online game. The given user and another user could have gifted or lent each other applications or virtual assets in the past. The given user and another user could have communicated over voice chat feature of one or more applications. Information regarding associations between the given user and other users could be included in the user information 103A. Collection of such information is greatly facilitated where applications are accessed and used via a common networking system associated with the game that the given user and other users can access.

In some implementations the screen may present an interactive selector 207 that allows the user to select criteria upon which the list 202 that will be based. In the illustrated example, the selector 207 includes radio buttons that allows the user to select or de-select whether the list 202 is based on applications that are owned, borrowed, shared, or belong to friends. The user can select or de-select the appropriate radio buttons with the cursor 206.

When the user selects an application on the filtered listing 202, as indicated at 108, the system automatically presents to the user a filtered catalog of purchasable virtual assets that are available to the user for the selected application, as indicated at 110. The filtered catalog of purchasable virtual assets is filtered according to the information about the user and/or the information about one or more computer applications associated with the user.

There are a number of ways in which the system can filter the list of virtual assets for each application according to user information 103A. For example, the catalog may be filtered according to the user demographic information, e.g., some add-ons might not be age-appropriate. The catalog presented could omit such virtual assets. The catalog may also be filtered according to the geographic information, e.g., certain virtual assets might not be available in certain areas. The catalog presented could omit such virtual assets. Furthermore, the catalog may be filtered according to device information, e.g., certain add-ons might not be available for use with certain machines. The catalog presented could omit such virtual assets. The filtering of the catalog of virtual assets could also be application context-dependent. For example, in the context of gaming applications, availability of some add-ons might be contingent upon the user accomplishing certain achievements within a game. The catalog presented could omit such virtual assets or indicate the nature of the contingency.

FIG. 3 illustrates a screen shot showing an example of how such a catalog may be presented to the user. In the illustrated example, the screen 200 shows the user the list 202 with the icons representing the 5 different applications depicted in FIG. 2. Here, the user has clicked on application 1 using the cursor 206 and the screen shows a catalog 208 with five virtual asset icons. In the illustrated example, each icon identifies the type of asset and a price to purchase the asset. Clicking on one of the asset icons may direct the user to a purchase page where the user can complete a transaction to purchase the asset. The catalog 208 may contain additional virtual assets but, if screen space is limited, the system might present the five most relevant assets as determined from the user information 103A and/or application information 103B. In this example, the user can view additional assets by clicking on the arrow 202 to the right of the icons using the cursor 204.

As noted above, the user may select a particular asset from the catalog for purchase. In such cases, the system may receive a purchase request from the user, as indicated at 112. The system may then deliver the asset (or access to the asset) to the user, as indicated at 114. In some implementations, the system may provide the user with an option to transfer the asset to another user, as indicated at 116. If the user elects this option, the system may then transfer the asset (or access to the asset) to the another user identified by the user who purchased the asset.

System

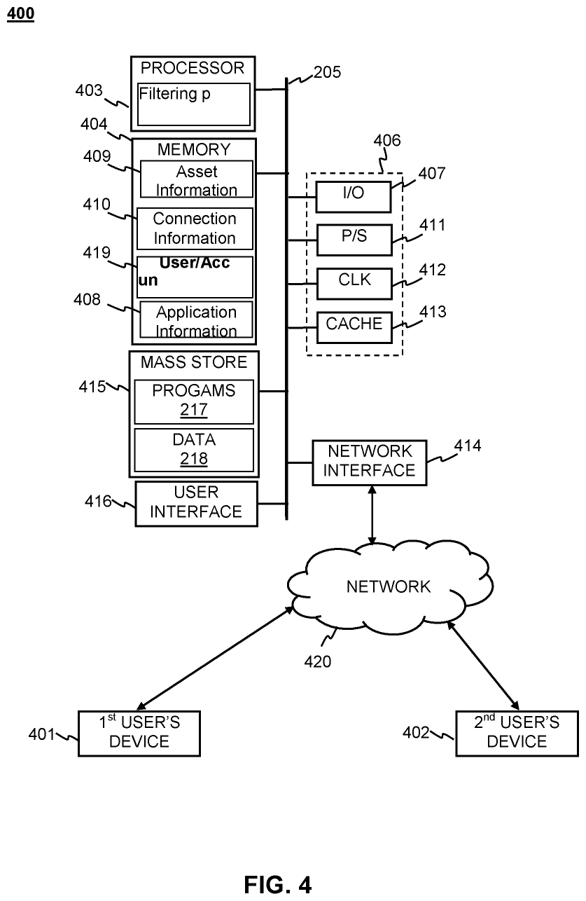

FIG. 4 depicts the system 400 configured to facilitate acquisition of virtual assets associated with a user according to aspects of the present disclosure. The system 400 may operate in conjunction with one or more user devices, e.g., a first user device 401 and a second user device 402.

The system 400 may include one or more processor units 403, which may be configured according to well-known architectures, such as, e.g., single-core, dual-core, quad-core, multi-core, processor-coprocessor, cell processor, and the like. The market place server may also include one or more memory units 404 (e.g., random access memory (RAM), dynamic random access memory (DRAM), read-only memory (ROM), and the like).

The processor unit 403 may execute one or more programs 417, portions of which may be stored in the memory 404 and the processor 403 may be operatively coupled to the memory, e.g., by accessing the memory via a data bus 305. The programs 317 may be configured to facilitate purchase of virtual assets for applications 408 according to the method 100 described above with respect to FIG. 1, FIG. 2, and FIG. 3. Additionally the Memory 404 may contain information about connections 410 between the system and one or more client devices 401, 402. Such connection information may include, e.g., internet protocol (IP) addresses, network address translator (NAT) traversal information, and connection performance information, such as bandwidth and latency. In addition, the Memory 404 may contain user account information 419, such as account identifiers, user profile information, and data indicating which applications are available to a given user. The Memory 404 may also contain data corresponding to virtual assets for the application 409. Alternatively, the virtual may be included in application data 408 or in a separate database (not shown). The virtual assets, applications and connection information may also be stored as data 418 in the Mass Store 418.

The system 400 may also include well-known support circuits, such as input/output (I/O) 407, circuits, power supplies (P/S) 411, a clock (CLK) 412, and cache 413, which may communicate with other components of the system, e.g., via the bus 405. The computing device may include a network interface 414. The processor unit 403 and network interface 414 may be configured to implement a local area network (LAN) or personal area network (PAN), via a suitable network protocol, e.g., Bluetooth, for a PAN. The computing device may optionally include a mass storage device 415 such as a disk drive, CD-ROM drive, tape drive, flash memory, or the like, and the mass storage device may store programs and/or data. The marketplace server may also include a user interface 416 to facilitate interaction between the system and a user. The user interface may include a monitor, Television screen, speakers, headphones or other devices that communicate information to the user.

The marketplace server 400 may include a network interface 414 to facilitate communication via an electronic communications network 420. The network interface 414 may be configured to implement wired or wireless communication over local area networks and wide area networks such as the Internet. The device 400 may send and receive data and/or requests for files via one or more message packets over the network 420. Message packets sent over the network 320 may temporarily be stored in a buffer in memory 404.

Although for simplicity the application 408 is shown as being stored in memory 404 on the marketplace server 400 aspects of the present disclosure are not limited to such implementations. In alternative implementations, code and data for the application 408 may be stored on a separate application server that can be remotely accessed by the marketplace server 400 and the client devices 401, 402.

As discussed above, certain aspects of the present disclosure may apply to situations where a first user has lent a game to a second user who wishes to purchase add-ons for the borrowed game. According to aspects of the present disclosure, an application delivery service may allow for a user (the borrower) to borrow an application from another user (the lender) and purchase virtual assets that are available for use with the borrowed applications but which the borrower (or lender) does not own. Additionally, the application delivery service may present users with a catalog of one or more virtual assets for applications they don't currently own but may be interested in owning or trying. For example, a user may enjoy a game they borrowed and purchase a virtual asset on the expectation that they will purchase the game and the virtual asset will be available for them to use after the purchase. Alternatively, the user may purchase a virtual asset for a borrowed game as a gift for the lender.

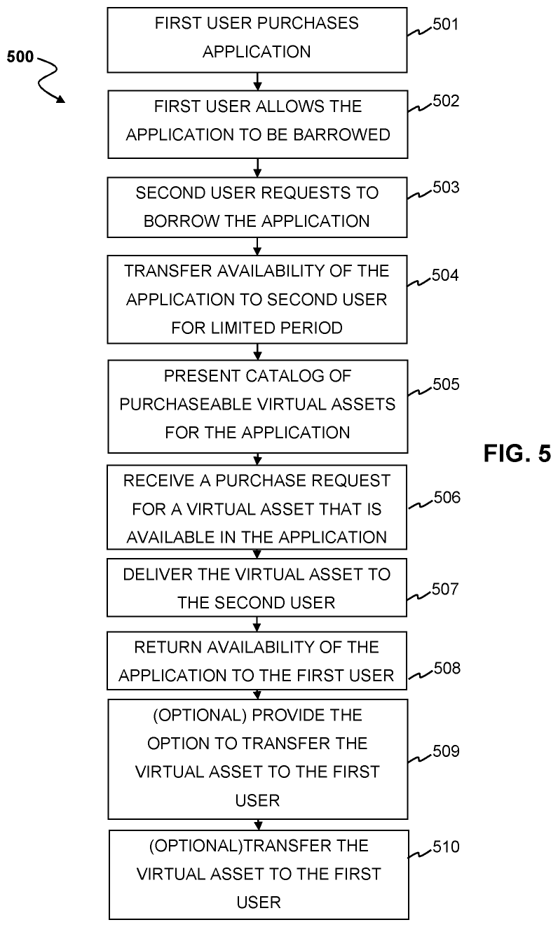

FIG. 5 shows a method for lending a virtual asset from a first user to a second user wherein the second user can purchase assets for the borrowed application. A virtual marketplace running on a remote server may provide an interface that allows a first user of the virtual marketplace to purchase an application, as indicated at 501. The application may be a video game, photo-editing program, music editing program, document-editing program, or the like. After purchasing the application the first user may be given the option to allow other users to borrow the application, as indicated at 502. A second user may send a request to the virtual market place to borrow the application from the first user, as indicated at 503.

Alternatively, the first user may simply send a message to the second user through the market place asking to borrow the application and the second user may send a message to the marketplace indicating that the first user is allowed to borrow the application. In this context borrowing, means that the application is, for a limited period of time, made unavailable to the first user, e.g., disabled or otherwise removed from the first user's device, and made available to the second user, e.g., downloaded, installed, or otherwise enabled on the second user's device. The “limited period of time” may be a fixed period of time, e.g., minutes, hours, days, weeks, months, or years, determined before or at the time the game is lent. Such a fixed period may be established by the first user, the second user, the virtual market place, or some mutual agreement among two or more of these entities. Alternatively, the duration of the “limited period of time” may be undetermined at the time the game is lent to the second user. For example, the application may be made available to the second user, e.g., downloaded, installed or otherwise enabled on the second user's device, until the first user requests that the application be returned.

In general, the borrowing of a game involves the assent of the first user before the game is lent to the second user. In some implementations, assent of a marketplace system may be required. After the request by the second user to borrow the application has been approved, the marketplace system transfers availability of the application from the first user to the second user, as indicated at 504. The application may be transferred by way of example and not by way of limitation allowing the second user to download the application from a database in connection with the marketplace server or from a memory of the marketplace server or from a peer to peer connection with the first user. Additionally, before, during or after the transfer the Application is removed or disabled for the user. In some implementations, e.g., cloud-based gaming, the bulk of the application code and data may be stored on an application server that users can access on different devices via user accounts. In such implementations, transfer of availability may be handled by the application server disabling access to the application from the first user's account while enabling access to the application from the second user's account. Such implementations may further involve the marketplace system sending executable code (e.g., for a user interface) and or machine-readable data (e.g., encryption keys) to the second user's device so that second user can communicate with the

While the second user is borrowing the application, a catalog of virtual assets for the application may be presented to the second user, as indicated at 505. The marketplace may present the catalog to the second user, e.g., by directing the second user to a web page that the second user can access via a browser on the second user's device. In some implementations according to aspects of the present disclosure the catalog of purchasable virtual assets for the application may be presented to the second user before sending the request to borrow the application from the first user at 503. By way of example and not by way limitation the virtual market place server may provide images of or lists of virtual assets for the application to the second user if the second user is friends with someone that owns the application or uses the application more than a threshold frequency, on a social media platform. In other embodiments the catalog of purchasable virtual assets may be presented to the second user if they recently clicked on an advertisement for the application or viewed a store page for the application.

The second user may purchase an asset for the application that the second user does not own, as indicated 506. The purchase may occur before the second user borrows the application from the user and the virtual asset may be delivered to the user in the form of a receipt or some other proof of purchase which the second user may redeem for the virtual asset, as indicated at 507. Alternatively, the second user may purchase the virtual asset after they have borrowed the application. In this case the virtual asset may be immediately delivered to the second user at 507. By way of example, and not by way of limitation, the virtual asset may be delivered to the second user by downloading executable code and/or machine-readable data representing the virtual asset within the application. Alternatively, the virtual asset may be delivered to the second user by enabling use of the virtual asset within the Application, e.g., through change of an access code associated with the second user's account. In some embodiments the second user may receive at least one warning that they are buying a virtual asset for an application that they do not own. Additionally the second user may be given the option to purchase the application or ask to borrow the application from another user.

In some implementations, the marketplace system may determine whether the first user is a friend of the second user and, if so, may present the second user with a catalog of other purchasable virtual assets that are available in other applications owned by the first user. There are a number of ways in which friendship between the first and second users may be determined. For example, the marketplace may be associated with or otherwise have access to data for a social media platform and the first and second users may indicate that they are friends on the social media platform. Alternatively, such friendship information may be directly associated with user accounts for both users on the application server.

After receiving the borrowed application from the first user the second user may use the application for a limited period of time. In some embodiments the limited period of time is chosen by the first user before the second user receives the application. In other embodiments the second user specifies the length of the borrowing period as part of the request to borrow the application from the first user. Alternatively, the first user may have the option to request the application be returned while the application is being borrowed by the second user. In some implementations, the marketplace system may determine or have a role in determining the limited period of time over which the application may be borrowed. In any case availability of the application is returned to the first user after the borrowing period has ended, as indicated at 508. Similar to delivering availability of the application to the second user, the first user may receive the application by downloading the application again. Alternatively the application may have been disabled when the first user chose to lend the application to the second user and in which case the application may be re-enabled. Disabling and re-enabling the application may come in the form of encrypting and decrypting the application data respectively. The first user may receive to decrypt the encrypted application after the borrowing period has ended. In other implementations, the marketplace system may simply enable access to the application from the first user's account and disable access to the application from the second user's account.

In some embodiments of the present disclosure the second user is provided the option to transfer the virtual asset to the first user after borrowing the application, as indicated at 109. The second user may be provided this option before borrowing the application or after purchasing the virtual asset or after transferring the application back to the first user or any other period during which the second user owns the virtual asset. In some embodiments second user may choose to send the virtual asset as a gift to the first for allowing them to borrow the application and in which case there may be gift options for the presentation of the virtual asset to the first user.

If the second user chooses to transfer the virtual asset to the second user, the virtual marketplace will deliver the virtual asset to the first user, as indicated at 110. As described above with respect to delivering the virtual asset to second user, the virtual asset may be delivered to the first user by downloading a piece of code for the application representing the virtual asset. Alternatively, the virtual asset may be enabled for the first user in a database. Or, the user may receive a key code that unlocks the virtual asset within the application or the virtual asset may be transferred to the first user through any other file delivery method. Once the virtual asset has been delivered to the first user, the virtual asset will be disabled, removed or rendered otherwise unusable to the second user. For example and without limitation a database entry providing the asset to the first user may be removed, or the program code for the virtual asset may deleted from the first user's device, or the code for the virtual asset may be encrypted on the first user's device without a key providing a key to the first user.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method, comprising;
obtaining information about a user and information about one or more computer applications associated with the user;
when the user navigates a device to a catalog screen for virtual assets for computer applications, automatically presenting to the user a filtered listing of applications for which purchasable virtual assets are available to the user, wherein the filtered listing of applications is filtered according to the information about the user and/or the information about one or more computer applications associated with the user;
when the user selects an application on the filtered listing, automatically presenting to the user a filtered catalog of purchasable virtual assets that are available to the user for the selected application, wherein the filtered catalog of purchasable virtual assets is filtered according to the information about the user and/or the information about one or more computer applications associated with the user.

2. The method of claim 1, wherein the filtered listing of applications is determined based at least on applications to which the user has access.

3. The method of claim 1, wherein the filtered listing of applications is determined based at least on applications that the user has access to by virtue of payment.

4. The method of claim 1, wherein the filtered listing of applications is determined based at least on applications that the user has used borrowed.

5. The method of claim 1, wherein the filtered listing of applications is determined based at least on applications which the user has opportunity to access through the user's association with other users.

6. The method of claim 1, wherein obtaining information about one or more computer applications associated with the user includes tracking applications that have been used by a device associated with the user.

7. The method of claim 1, wherein obtaining information about one or more computer applications associated with the user includes tracking applications loaded onto a device associated with the user.

8. The method of claim 1, further comprising receiving a request to purchase one or more virtual asset from the filtered catalog from the user; and
delivering the one or more purchased virtual assets to the user.

9. The method of claim 1, wherein the information about the user includes demographic information.

10. The method of claim 1, wherein the information about the user includes geographic information.

11. The method of claim 1, wherein the information about the user includes information regarding which application or applications the user has used most recently.

12. The method of claim 1, wherein the information about the user includes information regarding which application or applications the user uses most frequently.

13. The method of claim 1, wherein obtaining the information about the user includes tracking which application or applications the user has used most recently.

14. The method of claim 1, wherein obtaining the information about the user includes tracking which application or applications the user uses most frequently.

15. The method of claim 1, wherein the information about one or more computer applications associated with the user includes information about a device on which the user uses the one or more computer applications.

16. The method of claim 1, wherein the information about one or more computer applications associated with the user includes information about the user's history of use of the one or more computer applications.

17. The method of claim 1, further comprising;
transferring availability of an application owned by a second user to the user from the second user for a limited period of time before the user navigates the device to the catalog screen for virtual assets for computer applications,
wherein the filtered listing of applications for which purchasable virtual assets includes the application owned by the second user.

18. The method of claim 17, wherein said transferring availability of an application owned by a second user to the user from the second user for a limited period of time includes making the application unavailable to the second user during the limited period of time.

19. The method of claim 1, further comprising providing the user an option to gift a purchased virtual asset to a second user.

20. The method of claim 19, further comprising receiving a request to transfer the purchased virtual asset to the other user and transferring the virtual asset from the user to the second user.

21. The method of claim 1, wherein obtaining information about a user and information about one or more computer applications associated with the user includes identifying one or more other users associated with the user and identifying one or more corresponding applications associated with each identified other user.

22. A system, comprising:
a processor;
memory coupled to the processor;
non-transitory instructions embedded in the memory that when executed by the processor causes the processor to implement a method comprising;
obtaining information about a user and information about one or more computer applications associated with the user;
when the user navigates a device to a catalog screen for virtual assets for computer applications automatically presenting to the user a filtered listing of applications for which purchasable virtual assets are available to the user, wherein the filtered listing of applications is filtered according to the information about the user and/or the information about one or more computer applications associated with the user;
when the user selects an application on the filtered listing, automatically presenting to the user a filtered catalog of purchasable virtual assets that are available to the user for the selected application, wherein the filtered catalog of purchasable virtual assets is filtered according to the information about the user and/or the information about one or more computer applications associated with the user.

23. Non-transitory instructions embedded in a computer readable medium, that when executed by a processor cause the processor to implement a method comprising;
obtaining information about a user and information about one or more computer applications associated with the user;
when the user navigates a device to a catalog screen for virtual assets for computer applications automatically presenting to the user a filtered listing of applications for which purchasable virtual assets are available to the user, wherein the filtered listing of applications is filtered according to the information about the user and/or the information about one or more computer applications associated with the user;
when the user selects an application on the filtered listing, automatically presenting to the user a filtered catalog of purchasable virtual assets that are available to the user for the selected listing, wherein the filtered catalog of purchasable virtual assets is filtered according to the information about the user and/or the information about one or more computer applications associated with the user.
